(19) United States
(12) Patent Application Publication
(10) Pub. No.: US 2003/0152030 A1
(43) Pub. Date: Aug. 14, 2003

(54) Method and system for delayed connection release protocol

(76) Inventor: Stephen Hershey, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/074,760

(22) Filed: Feb. 12, 2002

(51) Int. Cl. H04L 12/56

(52) U.S. Cl. 370/236; 370/395.2

(57) ABSTRACT

A method and system for performing delayed connection release in a connection-oriented data link layer communications protocol, including a second node that establishes a return data link connection with a first node prior to an initial transmission of data from the first node to the second node and delays a release of the return data link connection after a last transmission of data from the first node to the second node. The second node also establishes a forward data link with the first node prior to an initial transmission of data from the second node to the first node and delays a release of the forward data link connection after a last transmission of data from the second node to the first node. The first node may be configured as a terminal and the second node may be configured as a base station over a wireless data link and the first node may be configured as a client and the second node may be configured as a server over a wired data link.

### BACKGROUND OF THE INVENTION

1. Field of the Invention

The present invention generally relates to communications and more particularly to a method and system for a connection-oriented packet data protocol employing delayed connection release.

2. Discussion of the Background

In a typical circuit-switched protocol design, a connection between data link layer send and receive entities exists for as long as a network layer connection exists. A persistent data link layer connection is employed because a circuit-switched application generates and transmits new data frequently and periodically. By contrast, a typical packet data application transmits data infrequently and aperiodically. Therefore, in most packet data protocol designs, the connection between data link layer send and receive entities may be established and released many times during a single network layer connection.

Various approaches to packet data protocol design have been implemented including connectionless and connection-oriented data link layer protocol designs. A connectionless data link layer protocol may not employ establishment of a session between two nodes (e.g., a terminal and a base station) before transmission may begin. For example, transmission of frames within a local area network (LAN), such as Ethernet, Token Ring, Fiber Distributed Data Interface (FDDI), etc., may be connectionless. User Datagram Protocol (UDP) packets within an Internet Protocol (IP) network also may be connectionless.

By contrast, a connection-oriented data link layer protocol may establish a session between two nodes before transmission may begin. When communications are completed, the session may be ended (i.e., torn down). For example, circuit-switched networks may be connection oriented because they may dedicate a channel for a duration of a session. The most ubiquitous circuit-switched network may be the Public Switched Telephone Network (PSTN). In addition, packet-switched X.25, frame relay, Asynchronous Transfer Mode (ATM), etc., networks also may be considered connection-oriented, because they may employ receiving nodes to acknowledge their ability to support a transmission before data may be sent.

ALOHA (Random, Slotted) is an example of a connectionless data link layer protocol. ALOHA is a type of TDMA transmission system used for satellite and terrestrial radio links. However, this protocol, being a connectionless data link layer protocol, may not be relevant with respect to connection-oriented protocols.

General Packet Radio Service (GPRS) is a connection-oriented data link layer protocol for terrestrial wireless packet data. GPRS enables continuous flows of IP data packets over the system for applications, such as Web browsing and file transfer. However, GPRS employs data link connections that survive only as long as there is demand for data link resources and may suffer from problems with respect to operation over links with large propagation delays, such as satellite data links, etc.

Broadband Radio Access Networks (BRAN) is a connection-oriented data link layer protocol for terrestrial wireless packet data. BRAN employs data link connections that may survive, even if there is no immediate demand for data link resources. However, BRAN employs a contention-based scheme by which a terminal with an existing connection and a new demand for link resources can request new resources from the network. Accordingly, a collision between two requests for link resources may result in a large increase in network Protocol Data Unit (PDU, a message sent from one network protocol entity to another, such as a TCP segment, a TCP ACK, etc.) transfer delay for the two connections affected, especially over links with large propagation delays. Further, the BRAN data link protocol may have significant performance disadvantages when operated over links with large propagation delays, such as satellite data links, etc.

TErrestrial Trunked RAdio (TETRA) Packet Data Optimized (PDO) is a connection-oriented data link layer protocol for terrestrial wireless packet data. TETRA PDO employs data link connections that survive as long as there is demand for data link resources. However, TETRA PDO may suffer from problems with respect to operation over links with large propagation delays, such as satellite data links, etc.

The UMTS data link protocol is a connectionless data link layer protocol for terrestrial wireless packet data. UMTS uses a contention-based access scheme. However, UMTS may not provide a network PDU transfer delay reduction over links with large propagation delays, such as satellite data links, etc.

The IEEE 802.11 wireless link layer protocol supports a network configuration consisting of a centralized network access point and mobile terminals. The network access point may employ a polling scheme to arbitrate access to the radio resource shared by the terminals. However, IEEE 802.11 may not support dynamically assigned and released data link connections. Instead, each terminal may employ a user-configured 6-byte Medium Access Control (MAC) address that may be different from the MAC addresses used by other terminals using the wireless network. Polling may be employed within IEEE 802.11 wireless networks to minimize collisions between terminals competing for a shared radio resource. However, IEEE 802.11 may suffer from problems with respect to operation over satellite data links, etc.

Therefore, there is a need for an improved connection-oriented packet data protocol to support links with large propagation delays, such as satellite data links, etc., as compared to other links.

### SUMMARY OF THE INVENTION

The above and other needs are addressed by the present invention, which provides an improved packet data protocol to support links with large propagation delays, such as satellite data links, etc., as compared to other links. The packet data protocol may employ a delayed connection release mechanism for use in a connection-oriented communications architecture.

Accordingly, in one aspect of the present invention there is provided a method and system for performing delayed connection release in a connection-oriented data link layer communications protocol, including establishing a return data link connection between a first node and a second node prior to an initial transmission of data from the first node to the second node; and delaying a release of the return data link connection after a last transmission of data from the first node to the second node.

In another aspect of the present invention there is provided a method and system for performing delayed connection release in a connection-oriented data link layer communications protocol, including establishing a forward data link connection between a second node and a first node prior to an initial transmission of data from the second node to the first node; and delaying a release of the forward data link connection after a last transmission of data from the second node to the first node.

In another aspect of the present invention there is provided a system configured to perform delayed connection release in a connection-oriented data link layer communications protocol, including a second node configured to establish a return data link connection with a first mode prior to an initial transmission of data from the first node to the second node; the second node configured to delay a release of the return data link connection after a last transmission of data from the first node to the second node; the second node configured to establish a forward data link with the first node prior to an initial transmission of data from the second node to the first node; and the second node configured to delay a release of the forward data link connection after a last transmission of data from the second node to the first node.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a system diagram illustrating an exemplary system, which may employ a Delayed Connection Release Protocol (DCRP), according to the present invention;

FIG. 2 is a flowchart for illustrating the Delayed Connection Release Protocol (DCRP) for forward flows, according to the present invention;

FIGS. 3a-3b are a flowchart for illustrating the Delayed Connection Release Protocol (DCRP) for return flows, according to the present invention; and

FIG. 4 is an exemplary computer system, which may be programmed to perform one or more of the processes of the present invention.

### DETAILED DESCRIPTION OF THE PREFERRED EMBODIMENTS

A method and system for a delayed connection release protocol (DCRP), are described. In the following description, for purposes of explanation, numerous specific details are set forth in order to provide a thorough understanding of the present invention. It is apparent to one skilled in the art, however, that the present invention may be practiced without these specific details or with an equivalent arrangement. In some instances, well-known structures and devices are shown in block diagram form in order to avoid unnecessarily obscuring the present invention.

The present invention includes recognition of advantages associated with releasing a data link connection, including, for example, (i) re-use of a Medium Access Control (MAC) address associated with a connection for a new connection, possibly with a different terminal, by a network data link controller; (ii) freeing up of network resources associated with a data link connection; (iii) for return connections, a network not having to employ periodic allocation of link resources to a terminal to check whether or not a new demand for the link resources exists; (iv) performance of idle-mode operations, such as discontinuous reception, monitoring of system information, etc., by a terminal, etc.

The present invention further includes recognition of disadvantages associated with releasing an idle data link connection, including, for example, a delay associated with reestablishing the data link connection if new data arrives at either a terminal or network for transfer to a peer (e.g., a functional unit that may be on a same protocol layer as another, etc.) entity, etc. Such a connection re-establishment delay may be due to propagation delay, lost signaling messages due to collision on contention channels, unavailability of network resources to support a requested connection, etc. For links with long propagation delays as compared to other links, such as satellite links, etc., such a problem may be particularly acute.

The Delayed Connection Release Protocol (DCRP) of the present invention adapts a packet data protocol to support, for example, satellite data links, etc., and may be employed in satellite networks, such as the General Mobile Packet Radio Service (GMPRS) (e.g., as further described in commonly owned U.S. patent application Ser. No. 09/963,352 of Hershey, entitled “METHOD, SYSTEM AND COMPUTER PROGRAM PRODUCT FOR BANDWIDTH-ON-DEMAND SIGNALING,” filed on Sep. 26, 2001, incorporated by reference herein), etc. The DCRP may mitigate a performance penalty associated with repeated data link connection establishments and releases by allowing a network to maintain data link connections despite no immediate demand for link resources. The network may also maintain or release an idle data link connection at any time as conditions warrant.

The DCRP, for example, advantageously, allows a network to reduce data link transfer delays experienced by the network PDUs associated with a particular network layer connection. Such delay reduction may be particularly pronounced over long-delay data links, such as satellite links, etc. The delay reduction provided by the DCRP may be advantageous for proper operation of delay-sensitive network layer protocols, such as Transmission Control Protocol (TCP), etc.

The DCRP protocol differs from its more well known cousin, GPRS. GPRS typically is employed in terrestrial packet data networks, where propagation delays are much less of an issue, as compared to satellite packet data networks. In GPRS, data link connections may be immediately released when no further demand for data link resources exists. GPRS assumes that an average data link connection re-establishment delay may be relatively small. By contrast, this may not be true for satellite links.

The DCRP may support dynamically assigned and released data link connections. The purpose of polling within wireless networks, such as GMPRS, etc., is to avoid a considerable delay associated with establishing and releasing data link connections. The data link connection establishment delay within such wireless networks may originate from several sources. For example, large propagation delays between a terminal and a base station, loss of connection establishment request or response messages, unavailability of radio resources, etc., may all contribute to unacceptably large data link connection establishment delays. Similarly, the release of data link connections may be delayed by lost connection release request or response messages.

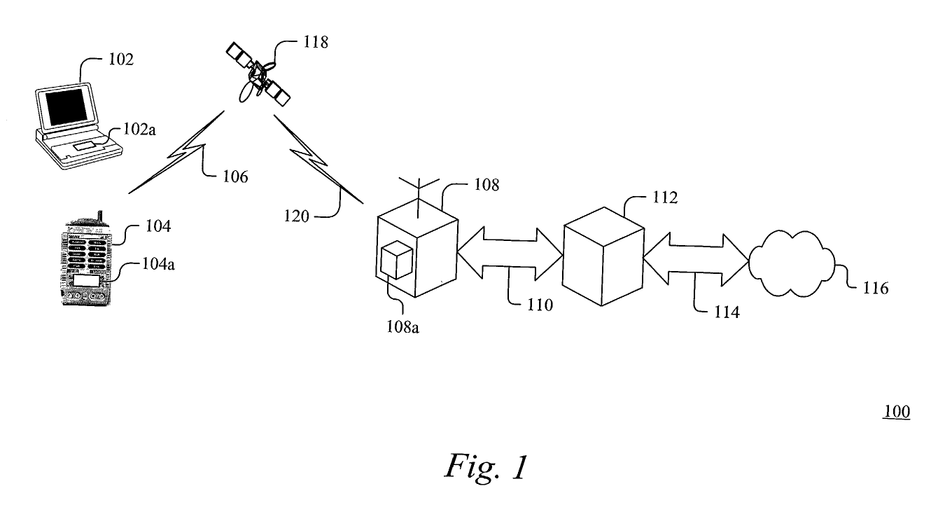

Referring now to the drawings, wherein like reference numerals designate identical or corresponding parts throughout the several views, and more particularly to FIG. 1 thereof, there is illustrated a system 100, which may employ a Delayed Connection Release Protocol (DCRP) of the present invention. In FIG. 1, the system 100 may include one or more wireless terminals (or clients) 102 and 104 coupled to a base station (or server) 108 via satellite 118 and data links 106 and 120. In one embodiment, each of the terminals 102 and 104 and the base station 108 may employ the DCRP in corresponding hardware and/or software DCRP devices 102a, 104a and 108a included therein. In another embodiment, a DCRP device (e.g., the DCRP device 108a) may be included in the satellite 118 and the DCRP may be employed in communications over the data link 106 and/or the data link 120.

The terminals 102 and 104 may communicate with the base station 108 via the satellite 118 and the data links 106 and 120 using the DCRP. One or more base stations 108 may be coupled to a gateway 112 via communications channel 110. The gateway 112 may be coupled to a communications network 116 (e.g., Public Switched Telephone Network (PSTN), Integrated Services Digital Network (ISDN), Packet Data Network (PDN), etc.) via communications channel 114.

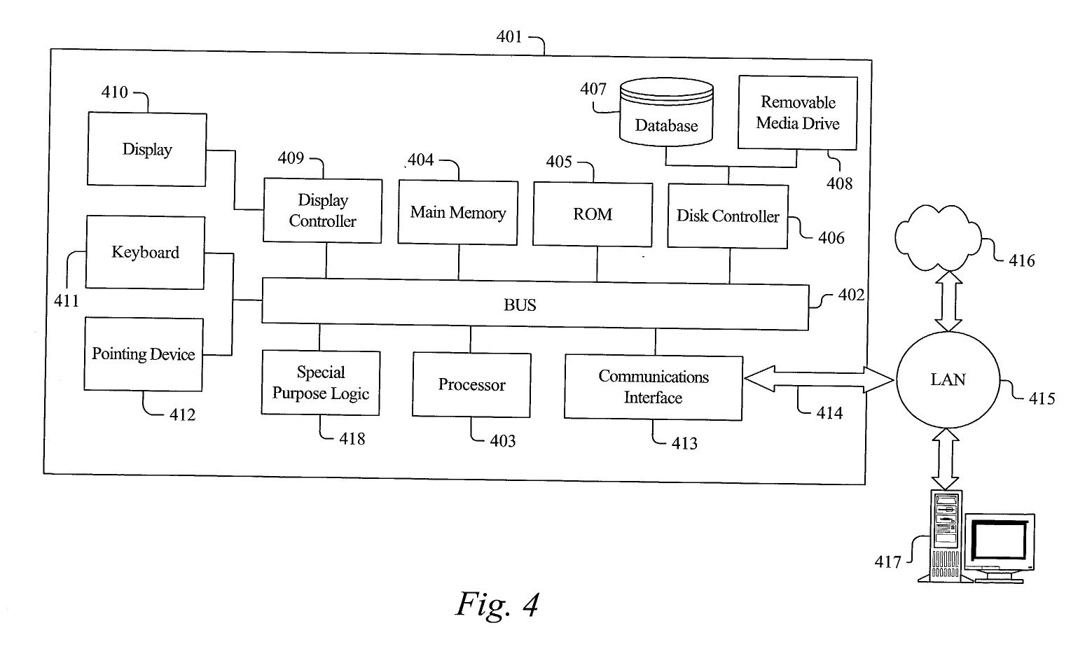

The terminals 102 and 104, the satellite 118, the base station 108 and the gateway 112 of system 100 may include any suitable servers, workstations, personal computers (PCs), personal digital assistants (PDAs), Internet appliances, set top boxes, other devices, etc., capable of performing the processes of the present invention. The base station 108 and the gateway 112 of the system 100 may communicate with each other using any suitable protocol via, for example, the communications channels 110 and 114. The terminals 102 and 104 and the base station 108 may be implemented using the computer system 401 of FIG. 4, for example. One or more interface mechanisms may be used in the system 100 including, for example, Internet access, telecommunications in any form (e.g., voice, modem, etc.), wireless communications media, etc., via the data link 106 and the communications channels 110 and 114.

In a preferred embodiment, the data links 106 and 120 may be implemented as a satellite communications data links. The communications channels 110 and 114 and the communications network 116 may include, for example, the Internet, an Intranet, wireless communications, satellite communications, cellular communications, hybrid communications, etc. If the system 100 is implemented as a satellite communications system, in one embodiment, the satellite 118 serves as a “bent pipe” and the DCRP may be terminated at the terminals 104 and 104 and the base station 108.

In another embodiment, a DCRP device (e.g., the DCRP device 108a) may be provided in the satellite 118 and the DCRP may be terminated at the satellite 118, the terminals 102, and 104 and the base station 108. In such embodiment, the data link 106 and/or the data link 120 may implement satellite communications using the DCRP. In other non-satellite embodiments, the terminals 102 and 104 may communicate directly with the base station 108 using the DCRP.

It is to be understood that the system in FIG. 1 is for exemplary purposes only, as many variations of the specific hardware used to implement the present invention are possible, as will be appreciated by those skilled in the relevant art(s). For example, the functionality of the terminals 102 and 104, the satellite 118, the base station 108 and the gateway 112 of the system 100 may be implemented via one or more programmed computers or devices. To implement such variations as well as other variations, a single computer (e.g., the computer system 401 of FIG. 4) may be programmed to perform the special purpose functions of, for example, the base station 108 and the gateway 112 shown in FIG. 1. On the other hand, two or more programmed computers or devices, for example as in shown FIG. 4, may be substituted for any one of the terminals 102 and 104, the satellite 118, the base station 108 and the gateway 112. Principles and advantages of distributed processing, such as redundancy, replication, etc., may also be implemented as desired to increase the robustness and performance of the system 100, for example.

In a preferred embodiment, the data links 106 and 120 may be implemented as a satellite communications data links and the communications channels 110 and 114 may be implemented via one or more communications channels (e.g., the Internet, an Intranet, a wireless communications channel, a satellite communications channel, a cellular communications channel, a hybrid communications channel, etc.), as will be appreciated by those skilled in the relevant art(s). In a preferred embodiment of the present invention, the data links 106 and 120 and the communications channels 110 and 114 preferably uses electrical, electromagnetic, optical signals, etc., that carry digital data streams, as are further described with respect to FIG. 4.

The following sections describe the DCRP, including the operation of the DCRP for a forward flow and a return flow, with references to FIGS. 1-3. In the context of the present invention, a flow may be stream of logically related network PDUs, the network PDUs may often be generated by a single application, a forward flow may be a flow originating in a network (e.g., the base station 108) and terminating on a terminal (e.g., the terminal 102 or 104), a return flow may be flow originating on a terminal (e.g., the terminal 102 or 104) and terminating in a network (e.g., the base station 108), a forward connection may be a data link (e.g., the data link 106 and/or 120) connection established from a network (e.g., the base station 108) to a terminal (e.g., the terminal 102 or 104) to transport network PDUs associated with a forward flow, and a return connection may be a data link (e.g., the data link 106 and/or 120) connection established from a terminal (e.g., the terminal 102 or 104) to a network (e.g., the base station 108) to transport network PDUs associated with a return flow.

The base station 108 may manage wireless communication traffic within a finite geographical area. The terminal 102 or 104 (e.g., a wireless terminal) may be implemented as a mobile terminal and may include user applications, such as a web-browser, e-mail application, etc.

The base station 108 may arbitrate access to radio resources by the terminals 102 or 104. This arbitration may include granting, rejecting, etc., requests for new data link 106 and/or 120 connections from the terminals 102 or 104, scheduling transmission of packets associated with existing data link 106 and/or 120 connections, and releasing data link 106 and/or 120 connections. The base station may manage both the forward data link 103 and/or 120 connections (e.g., data sent from the base station 108 to the terminal 102 or 104) and the return data link 106 and/or 120 connections (e.g., data sent from the terminal 102 or 104 to the base station 108).

### Delayed Connection Release Protocol for Forward Flows

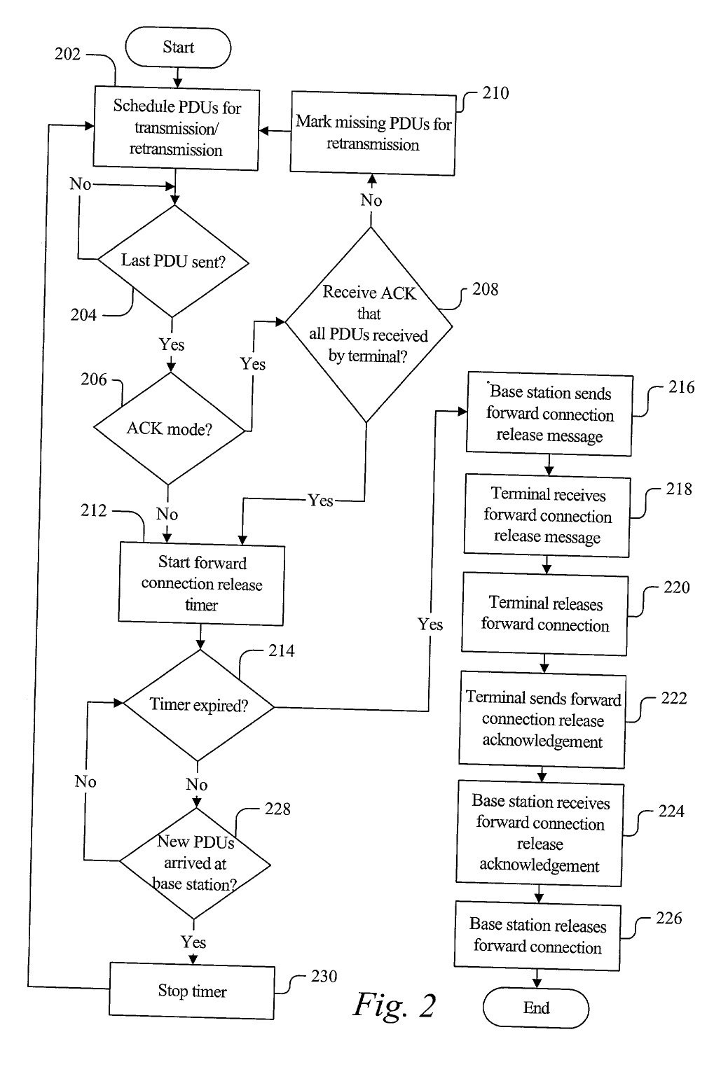

FIG. 2 is a flowchart for illustrating the Delayed Connection Release Protocol (DCRP) for forward flows. In FIG. 2, at step 202 the base station 108 schedules PDUs for transmission or retransmission. At step 204, the base station 108 determines if the last network PDU awaiting transmission has been sent to the terminal 102 or 104. When the last network PDU awaiting transmission is sent to the terminal 102 or 104 as determined by step 204 and if the data link 106 and/or 120 is operating in unacknowledged mode as determined at step 206, then the base station 108 starts a forward connection release timer (e.g., implemented via hardware and/or software) at step 212 to delay a release of the forward connection.

If, however, the base station 108 determines at step 206 that the data link 106 and/or 120 is operating in acknowledged (ACK) mode, the base station 108 at step 208 determines whether or not the base station 108 has received an acknowledgement that all network PDUs sent to the terminal 102 or 104 have been received by the terminals 102 or 104. If both conditions are satisfied, the base station 108 starts the forward connection release timer at step 212 to delay a release of the forward connection. Otherwise, the base station 108 marks missing PDUs for retransmission at step 210 and control returns to step 202 for transferring of any missing PDUs.

When the forward connection release timer expires as determined by step 214, the base station 108 sends a Forward Connection Release message to the terminal 102 or 104 at step 216. The terminal 102 or 104 receives the Forward Connection Release message at step 218 and releases the forward connection at step 220. The terminal 102 or 104 replies with a Forward Connection Release Acknowledgement message at step 222. At step 224, the base station 108 receives the Forward Connection Release Acknowledgement message and releases the forward connection at step 226, completing the process.

If, however, new network PDUs arrive at the base station 108 for transmission to the terminal 102 or 104 as determined at step 228 while the forward connection release timer is running as determined by step 214, the timer is stopped at step 230 and control is transferred to step 202. The timer then may be restarted at step 212 after the transfer of the new network PDUs is completed via steps 212, 214, 228, 230 and 202-210. The new network PDUs, advantageously, experience much less delay than if tear down and re-establishment of the forward data link connection had been employed prior to the transfer of the new network PDUs via steps 212, 214, 228, 230 and 202-210.

The duration of the forward connection release timer for a particular forward connection may be under the control of the base station 108. The base station 108 may set the duration of the forward connection release timer to an appropriate value (e.g., from zero to infinity) in order to achieve a desired performance objective.

### Delayed Connection Release Protocol for Return Flows

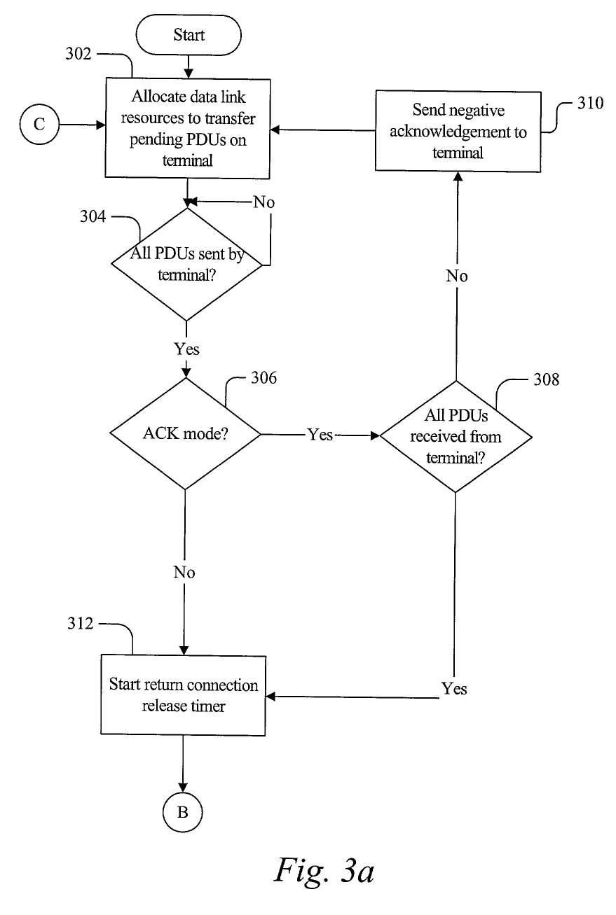

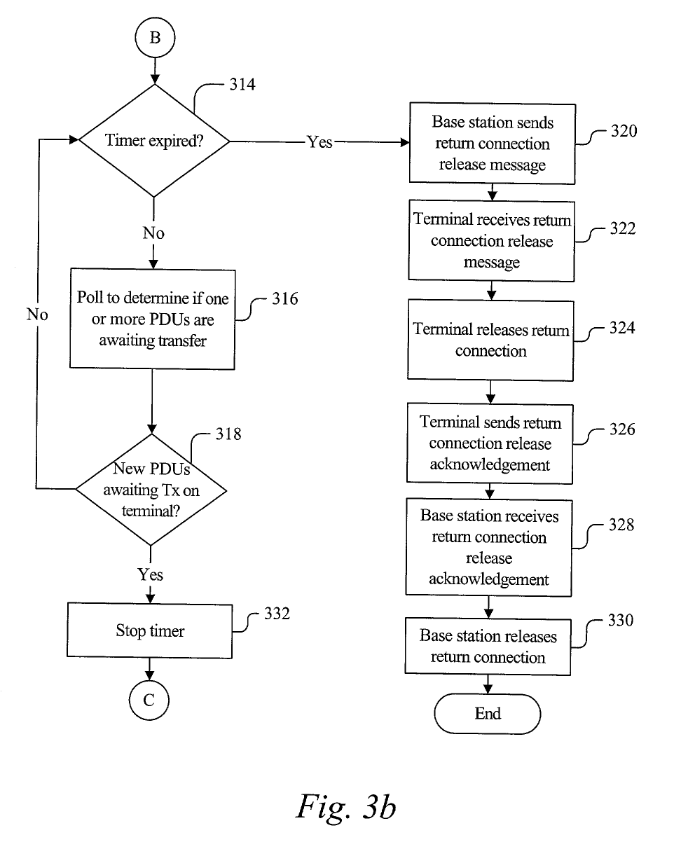

FIGS. 3a-3b are a flowchart for illustrating the Delayed Connection Release Protocol (DCRP) for return flows. In FIG. 3a, at step 302 the base station 108 allocates data link 106 and/or 120 resources for transferring PDUs pending on the terminal 102 or 104 to the base station 108. At step 304, the base station 108 determines if all the pending PDUs have been sent by the terminal 102 or 104.

If the data link 106 and/or 120 connection is operating in unacknowledged mode as determined in step 306, then the base station 108 starts a return connection release timer (e.g, implemented via software and/or hardware) at step 312 to delay a release of the return connection. If the data link 106 and/or 120 connection is operating in acknowledged mode as determined in step 306, then the base station 108 starts the return connection release timer at step 312 to delay a release of the return connection after the base station 108 receives an indication from the terminal 102 or 104 that all pending network PDUs have been received from the terminal 102 or 104 as determined in step 308. Otherwise, at step 310 the base station 108 sends a negative acknowledgement message to the terminal 102 or 104 and control transfers back to step 302 for transferring of any negatively acknowledged and/or new PDUs pending at the terminal 102 or 104.

When the return connection release timer expires as determined in step 314, the base station 108 sends a Return Connection Release message to the terminal 102 or 104 at step 320. At step 322, the terminal 102 or 104 receives the Return Connection Release message and releases the return connection at step 324. The terminal 102 or 104 then replies with a Return Connection Release Acknowledgement message at step 326. The base station 108 receives the Return Connection Release Acknowledgement message at step 328 and releases the return connection at step 330, completing the process.

While the return connection release timer is running as determined in step 314, the base station 108 occasionally (e.g., periodically, etc.) polls the terminal 102 or 104 at step 316 to determine if one or more new network PDUs are awaiting transfer. If the base station 108 receives an indication from the terminal 102 or 104 that new network PDUs are awaiting transfer as determined in step 318, the base station 108 then stops the return connection release timer as step 332, and control is transferred back to step 302. The timer then may be restarted at step 312 after the transfer of the new network PDU is completed via steps 312, 314, 316, 318, 332 and 302-310. The network PDU, advantageously, experiences much less delay than if re-establishment of the return data link 106 connection had been employed prior to the transfer of the new PDUs via steps 312, 314, 316, 318, 332 and 302-310.

The duration of the return connection release timer for a particular return connection may be entirely under the control of the base station 108. The base station 108 may set the duration of the return connection release timer to an appropriate value (e.g., from zero to infinity) in order to achieve a desired performance objective.

The polling of idle return connections (step 316) for newly pending network PDUs (as determined in step 318) may not negatively impact the servicing of return connections with known demand. The polling may also be performed sufficiently often to ensure that the base station 108 may be notified promptly when new network PDUs are pending on the terminal 120 or 104. A data link 106 and/or 120 resource scheduler (not shown) of the base station 108 may be implemented so as to balance the noted concerns.

Accordingly, the present invention is applicable to “wireless” communications as between the base station 108 and the terminal 102 or 104 over the wireless data link 102 and/or 120. In addition, the present invention is also applicable to “wired” communications as between a server (e.g., performing the DCRP functions performed by the base station 108) and a client (e.g., performing the DCRP functions performed by the terminal 102 or 104) over a wired data link (e.g., by replacing the satellite 118 with a wired communications network, by replacing the wireless data links 106 and 120 by wired data links, etc.), as will be appreciated by those skilled in the relevant art(s). In the context of the present invention, a “node” may refer to the base station 108 and/or the terminal 102 or 104 during wireless communications and to a client and/or a server during wired communications.

The present invention may store information relating to various processes described herein. This information may be stored in one or more memories, such as a hard disk, optical disk, magneto-optical disk, RAM, etc. One or more databases, such as databases within the terminals 102 and 104, the base station 108, the gateway 112, etc., of the system 100, may store the information used to implement the present invention. The databases may be organized using data structures (e.g., records, tables, arrays, fields, graphs, trees, and/or lists) included in one or more memories, such as the memories listed above or any of the storage devices listed below in the discussion of FIG. 4, for example.

The previously described processes may include appropriate data structures for storing data collected and/or generated by the processes of the system 100 of FIG. 1 in one or more databases thereof. Such data structures accordingly may include fields for storing such collected and/or generated data. In a database management system, data may be stored in one or more data containers, each container including records, and the data within each record may be organized into one or more fields. In relational database systems, the data containers may be referred to as tables, the records may be referred to as rows, and the fields may be referred to as columns. In object-oriented databases, the data containers may be referred to as object classes, the records may be referred to as objects, and the fields may be referred to as attributes. Other database architectures may be employed and use other terminology. Systems that implement the present invention may not be limited to any particular type of data container or database architecture.

The present invention (e.g., as described with respect to FIGS. 1-3) may be implemented by the preparation of application-specific integrated circuits or by interconnecting an appropriate network of conventional component circuits, as will be appreciated by those skilled in the electrical art(s). In addition, all or a portion of the invention (e.g., as described with respect to FIGS. 1-3) may be conveniently implemented using one or more conventional general purpose computers, microprocessors, digital signal processors, micro-controllers, etc., programmed according to the teachings of the present invention (e.g., using the computer system of FIG. 4), as will be appreciated by those skilled in the computer and software art(s). Appropriate software can be readily prepared by programmers of ordinary skill based on the teachings of the present disclosure, as will be appreciated by those skilled in the software art. Further, the present invention may be implemented on the World Wide Web (e.g., using the computer system of FIG. 4).

FIG. 4 illustrates a computer system 401 upon which the present invention (e.g., the terminals 102 and 104, the base station 108, the gateway 112, the system 100, etc.) may be implemented. The present invention may be implemented on a single such computer system, or a collection of multiple such computer systems. The computer system 401 may include a bus 402 or other communication mechanism for communicating information, and a processor 403 coupled to the bus 402 for processing the information. The computer system 401 also may include a main memory 404, such as a random access memory (RAM), other dynamic storage device (e.g., dynamic RAM (DRAM), static RAM (SRAM), synchronous DRAM (SDRAM)), etc., coupled to the bus 402 for storing information and instructions to be executed by the processor 403. In addition, the main memory 404 also may be used for storing temporary variables or other intermediate information during the execution of instructions by the processor 403. The computer system 401 further may include a read only memory (ROM) 405 or other static storage device (e.g., programmable ROM (PROM), erasable PROM (EPROM), electrically erasable PROM (EEPROM), etc.) coupled to the bus 402 for storing static information and instructions.

The computer system 401 also may include a disk controller 406 coupled to the bus 402 to control one or more storage devices for storing information and instructions, such as a magnetic hard disk 407, and a removable media drive 408 (e.g., floppy disk drive, read-only compact disc drive, read/write compact disc drive, compact disc jukebox, tape drive, and removable magneto-optical drive). The storage devices may be added to the computer system 401 using an appropriate device interface (e.g., small computer system interface (SCSI), integrated device electronics (IDE), enhanced-IDE (E-IDE), direct memory access (DMA), or ultra-DMA).

The computer system 401 also may include special purpose logic devices 418, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, satellite communications transceiver functions, base station functions, data link resource scheduling functions, DCRP functions, etc.

The computer system 401 also may include a display controller 409 coupled to the bus 402 to control a display 410, such as a cathode ray tube (CRT), liquid crystal display (LCD), active matrix display, plasma display, touch display, etc., for displaying or conveying information to a computer user. The computer system may include input devices, such as a keyboard 411 including alphanumeric and other keys and a pointing device 412, for interacting with a computer user and providing information to the processor 403. The pointing device 412 may include, for example, a mouse, a trackball, a pointing stick, etc., or voice recognition processor, etc., for communicating direction information and command selections to the processor 403 and for controlling cursor movement on the display 410. In addition, a printer may provide printed listings of the data structures/information of the system shown in FIG. 1, or any other data stored and/or generated by the computer system 401.

The computer system 401 may perform a portion or all of the processing steps of the invention in response to the processor 403 executing one or more sequences of one or more instructions contained in a memory, such as the main memory 404. Such instructions may be read into the main memory 404 from another computer readable medium, such as a hard disk 407 or a removable media drive 408. Execution of the arrangement of instructions contained in the main memory 404 causes the processor 403 to perform the process steps described herein. One or more processors in a multi-processing arrangement also may be employed to execute the sequences of instructions contained in main memory 404. In alternative embodiments, hard-wired circuitry may be used in place of or in combination with software instructions. Thus, embodiments are not limited to any specific combination of hardware circuitry and/or software.

Stored on any one or on a combination of computer readable media, the present invention may include software for controlling the computer system 401, for driving a device or devices for implementing the invention, and for enabling the computer system 401 to interact with a human user (e.g., users of the system 100 of FIG. 1, etc.). Such software may include, but is not limited to, device drivers, operating systems, development tools, and applications software. Such computer readable media further may include the computer program product of the present invention for performing all or a portion (if processing is distributed) of the processing performed in implementing the invention. Computer code devices of the present invention may include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the present invention may be distributed for better performance, reliability, and/or cost.

The computer system 401 also may include a communication interface 413 coupled to the bus 402. The communication interface 413 may provide a two-way data communication coupling to a network link 414 that is connected to, for example, a local area network (LAN) 415, or to another communications network 416, such as the Internet. For example, the communication interface 413 may include a digital subscriber line (DSL) card or modem, an integrated services digital network (ISDN) card, a cable modem, a telephone modem, etc., to provide a data communication connection to a corresponding type of telephone line. As another example, communication interface 413 may include a local area network (LAN) card (e.g., for Ethernet™, an Asynchronous Transfer Model (ATM) network, etc.), etc., to provide a data communication connection to a compatible LAN. Wireless links may also be implemented. In any such implementation, communication interface 413 may send and receive electrical, electromagnetic, or optical signals that carry digital data streams representing various types of information. Further, the communication interface 413 may include peripheral interface devices, such as a Universal Serial Bus (USB) interface, a PCMCIA (Personal Computer Memory Card International Association) interface, etc.

The network link 414 typically may provide data communication through one or more networks to other data devices. For example, the network link 414 may provide a connection through local area network (LAN) 415 to a host computer 417, which has connectivity to a network 416 (e.g. a wide area network (WAN) or the global packet data communication network now commonly referred to as the “Internet”) or to data equipment operated by service provider. The local network 415 and network 416 both may employ electrical, electromagnetic, or optical signals to convey information and instructions. The signals through the various networks and the signals on network link 414 and through communication interface 413, which communicate digital data with computer system 401, are exemplary forms of carrier waves bearing the information and instructions.

The computer system 401 may send messages and receive data, including program code, through the network(s), network link 414, and communication interface 413. In the Internet example, a server (not shown) may transmit requested code belonging to an application program for implementing an embodiment of the present invention through the network 416, LAN 415 and communication interface 413. The processor 403 may execute the transmitted code while being received and/or store the code in storage devices 407 or 408, or other non-volatile storage for later execution. In this manner, computer system 401 may obtain application code in the form of a carrier wave. With the system of FIG. 4, the present invention may be implemented on the Internet as a Web Server 401 performing one or more of the processes according to the present invention for one or more computers coupled to the Web server 401 through the network 416 coupled to the network link 414.

The term “computer readable medium” as used herein may refer to any medium that participates in providing instructions to the processor 403 for execution. Such a medium may take many forms, including but not limited to, non-volatile media, volatile media, transmission media, etc. Non-volatile media may include, for example, optical or magnetic disks, magneto-optical disks, etc., such as the hard disk 407 or the removable media drive 408. Volatile media may include dynamic memory, etc., such as the main memory 404. Transmission media may include coaxial cables, copper wire and fiber optics, including the wires that make up the bus 402. Transmission media may also take the form of acoustic, optical, or electromagnetic waves, such as those generated during radio frequency (RF) and infrared (IR) data communications. As stated above, the computer system 401 may include at least one computer readable medium or memory for holding instructions programmed according to the teachings of the invention and for containing data structures, tables, records, or other data described herein. Common forms of computer-readable media may include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer connected to either of networks 415 and 416. In such a scenario, the remote computer may load the instructions into main memory and send the instructions, for example, over a telephone line using a modem. A modem of a local computer system may receive the data on the telephone line and use an infrared transmitter to convert the data to an infrared signal and transmit the infrared signal to a portable computing device, such as a personal digital assistant (PDA), a laptop, an Internet appliance, etc. An infrared detector on the portable computing device may receive the information and instructions borne by the infrared signal and place the data on a bus. The bus may convey the data to main memory, from which a processor retrieves and executes the instructions. The instructions received by main memory may optionally be stored on storage device either before or after execution by processor.

The DCRP of the present invention, advantageously, may be employed in the International Maritime Satellite (Inmarsat) Early Entry data link protocol of the Early Entry Packet Data System. The DCRP also may be employed in any packet data applications deploying a connection-oriented data link layer over data links with long propagation delays, such as a satellite data link, etc., as will be appreciated by those skilled in the relevant art(s).

While the present invention has been described in connection with a number of embodiments and implementations, the present invention is not so limited but rather covers various modifications and equivalent arrangements, which fall within the purview of the appended claims.

What is claimed is:

1. A method for a delayed connection release in a connection-oriented data link layer communications protocol, comprising:
establishing a return data link connection between a first node and a second node prior to an initial transmission of data from the first node to the second node; and
delaying a release of the return data link connection after a last transmission of data from the first node to the second node.

2. The method of claim 1, wherein the first node functions as a terminal and the second node functions as a base station over a wireless data link.

3. The method of claim 1, wherein the first node is configured as a client and the second node is configured as a server over a wired data link.

4. The method of claim 1, further comprising the second node determining if the first node desires to transmit new data to the second node, during the delayed release of the return data link connection.

5. The method of claim 4, further comprising delaying the release of the return data link connection based on a return connection release timer.

6. The method of claim 5, further comprising releasing the return data link connection, if it is determined that first node has no more data to transmit to the second node and if the return connection release timer has expired.

7. The method of claim 4, further comprising delaying the release of the return data link connection by stopping the return connection release timer, if it is determined that first node desires to transmit the new data to the second node.

8. The method of claim 7, further comprising the second node allocating return data link connection resources for the transmission of the new data from the first node to the second node over the established return data link connection.

9. The method of claim 1, further comprising the second node determining if the first node is configured to receive an acknowledgement for data transmitted from the first node to the second node.

10. The method of claim 9, further comprising the second node sending a negative acknowledgement for a first node data transmission, if it is determined that the transmission of data from the first node to the second node has failed.

11. A computer-readable medium carrying one or more sequences of one or more instructions, the one or more sequences of one or more instructions including instructions which, when executed by one or more processors, cause the one or more processors to perform the steps recited in claim 1.

12. A system for delayed connection release in a connection-oriented data link layer communications protocol, comprising:
means for establishing a return data link connection between a first node and a second node prior to an initial transmission of data from the first node to the second node; and
means for delaying a release of the return data link connection after a last transmission of data from the first node to the second node.

13. A system configured to perform delayed connection release in a connection-oriented data link layer communications protocol, comprising:
a second node configured to establish a return data link connection with a first node prior to an initial transmission of data from the first node to the second node; and
the second node configured to delay a release of the return data link connection after a last transmission of data from the first node to the second node.

14. The system of claim 13, wherein the first node is configured as a terminal and the second node is configured as a base station over a wireless data link.

15. The system of claim 13, wherein the first node is configured as a client and the second node is configured as a server over a wired data link.

16. The system of claim 13, wherein the second node is configured to determine if the first node desires to transmit new data to the second node, during the delayed release of the return data link connection.

17. The system of claim 16, further comprising a return connection release timer configured to delay the release of the return data link connection.

18. The system of claim 17, wherein the second node is configured to release the return data link connection, if it is determined that first node has no more data to transmit to the second node and if the return connection release timer has expired.

19. The system of claim 16, wherein the second node is configured to delay the release of the return data link connection by stopping the return connection release timer, if it is determined that first node desires to transmit the new data to the second node.

20. The system of claim 19, wherein the second node is configured to allocate return data link connection resources for the transmission of the new data from the first node to the second node over the established return data link connection.

21. The system of claim 13, wherein the second node is configured to determine if the first node is configured to receive an acknowledgement for data transmitted from the first node to the second node.

22. The system of claim 21, wherein the second node is configured to send a negative acknowledgement for a first node data transmission, if it is determined that the transmission of data from the first node to the second node has failed.

23. A method for a delayed connection release in a connection-oriented data link layer communications protocol, comprising:
establishing a forward data link connection between a second node and a first node prior to an initial transmission of data from the second node to the first node; and
delaying a release of the forward data link connection after a last transmission of data from the second node to the first node.

24. The method of claim 23, wherein the first node functions as a terminal and the second node functions as a base station over a wireless data link.

25. The method of claim 23, wherein the first node is configured as a client and the second node is configured as a server over a wired data link.

26. The method of claim 23, further comprising the second node determining if new data has arrived at the second node for transmission to the first node, during the delayed release of the forward data link connection.

27. The method of claim 26, further comprising delaying the release of the forward data link connection based on a forward connection release timer.

28. The method of claim 27, further comprising releasing the forward data link connection, if it is determined that new data has not arrived at the second node for transmission to the first node and if the forward connection release timer has expired.

29. The method of claim 26, further comprising delaying the release of the forward data link connection by stopping the forward connection release timer, if it is determined that new data has arrived at the second node for transmission to the first node.

30. The method of claim 29, further comprising the second node scheduling the new data for the transmission from the second node to the first node over the established forward data link connection.

31. The method of claim 23, further comprising the second node determining if the first node is configured to acknowledge a transmission of data from the second node to the first node.

32. The method of claim 31, further comprising the second node marking missing data for retransmission from the second node to the first node, if it is determined that the transmission of data from the second node to the first node has failed.

33. A computer-readable medium carrying one or more sequences of one or more instructions, the one or more sequences of one or more instructions including instructions which, when executed by one or more processors, cause the one or more processors to perform the steps recited in claim 23.

34. A system for delayed connection release in a connection-oriented data link layer communications protocol, comprising:
means for establishing a forward data link connection between a second node and a first node prior to an initial transmission of data from the second node to the first node; and
means for delaying a release of the forward data link connection after a last transmission of data from the second node to the first node.

35. A system configured to perform delayed connection release in a connection-oriented data link layer communications protocol, comprising:
a second node configured to establish a forward data link with a first node prior to an initial transmission of data from the second node to the first node; and
the second node configured to delay a release of the forward data link connection after a last transmission of data from the second node to the first node.

36. The system of claim 35, wherein the first node is configured as a terminal and the second node is configured as a base station over a wireless data link.

37. The system of claim 35, wherein the first node is configured as a client and the second node is configured as a server over a wired data link.

38. The system of claim 35, wherein the second node is configured to determine if new data has arrived at the second node for transmission to the first node, during the delayed release of the forward data link connection.

39. The system of claim 38, further comprising a forward connection release timer configured to delay the release of the forward data link connection.

40. The system of claim 39, wherein the second node is configured to release the forward data link connection, if it is determined that new data has not arrived at the second node for transmission to the first node and if the forward connection release timer has expired.

41. The system of claim 38, wherein the second node is configured to delay the release of the forward data link connection by stopping the forward connection release timer, if it is determined that new data has arrived at the second node for transmission to the first node.

42. The system of claim 41, wherein the second node is configured to schedule the new data for the transmission from the second node to the first node over the established forward data link connection.

43. The system of claim 35, wherein the second node is configured to determine if the first node is configured to acknowledge a transmission of data from the second node to the first node.

44. The system of claim 43, wherein the second node is configured to mark missing data for retransmission from the second node to the first node, if it is determined that the transmission of data from the second node to the first node has failed.

45. A system configured to perform delayed connection release in a connection-oriented data link layer communications protocol, comprising:
a second node configured to establish a return data link connection with a first node prior to an initial transmission of data from the first node to the second node;
the second node configured to delay a release of the return data link connection after a last transmission of data from the first node to the second node;
the second node configured to establish a forward data link with the first node prior to an initial transmission of data from the second node to the first node; and
the second node configured to delay a release of the forward data link connection after a last transmission of data from the second node to the first node.

46. The system of claim 45, wherein the first node is configured as a terminal and the second node is configured as a base station over a wireless data link.

47. The system of claim 45, wherein the first node is configured as a client and the second node is configured as a server over a wired data link.
